(19) United States
(12) Patent Application Publication
(10) Pub. No.: US 2015/0054288 A1
(43) Pub. Date: Feb. 26, 2015

(54) Rotary Linear Generator (stroke-rotor generator)

(71) Applicant: Wolfhart Hans Willimczik, Bradenton, FL (US)

(72) Inventor: Wolfhart Hans Willimczik, Bradenton, FL (US)

(21) Appl. No.: 13/972,638

(22) Filed: Aug. 21, 2013

(51) Int. Cl. F02B 63/04

(52) U.S. Cl. CPC F02B 63/04
USPC 290/1 A

(57) ABSTRACT

This rotary linear generator comprises of one rigid part making a linear reciprocating movement superimposed by a rotational movement around the center axis—in short: a “rotating stroke motion”.

Linear generators will be improved by adding a rotational motion to the reciprocating motion. This can be achieved by mechanical bearings, slanted magnetic bearings or by adding a conventional electric motor or by a combination of them.

The benefits are twofold; as driving engines may now utilised simple environmental friendly two stroke engines with rotating pistons, secondly conventional rotating generators may also be used for generating electrical energy. Even at a desired low sliding speed of the pistons the desired high speed between the two interacting magnetic fields can be high depending on the diameter of the rotating part of the generator. Several versions of this idea are shown.

### FIELD OF THE INVENTION

This invention belongs to the field of linear generators or free piston generators etc.

### BACKGROUND ART

Today's linear generators, for instance according to the author's invention (German Patent DE2519912A1 Feb. 19, 1976) are used to produce electrical energy making a linear reciprocating motion only. They don't use environmental friendly two-stroke engines like this one from the author with rotating reciprocating pistons: U.S. application Ser. No. 13/012,973 filed 25 Jan. 2011.

### SUMMARY OF THE INVENTION

Two problems shell be solved by this invention: firstly an environmental friendly two-stroke engine shell be used and secondly the performance of the electrical part of linear generators shell be improved.

To do this a rotation is added to the reciprocating or stroke motion respectively. There is always one rigid moveable part only, what is rotational symmetrically—ergo able to rotate simultaneously to the reciprocating movement. Than can be used pistons and cylinders from a two-stroke engine—for instance the one from the author—to drive such “rotational linear generator”, because the pistons make already such “rotating stroke motion”. To add a rotation a slanted mechanical bearing (drive gear) can be used, a slanted magnetically bearing or a combination of both. The simplest way to add a rotation is of course by adding a rotating electrical motor. All extra devices will not change one motion in another one, but only add one motion to the other. The rotation and the reciprocation are synchronized—magnetically in conjunction with a computerized power unit or mechanically.

The mechanical axial bearing consists of a slanted non-rotating ring around the shaft sliding between two slanted surfaces connected with the shaft. The ring in the middle is rigidly connected to a ball via a radial directed strong pin. This ball is anchored in a stationary body and moveable only around its center. In this way a rotation of the shaft will add a stroke motion along the centerline of the shaft or a stroke motion of pistons will add a rotation respectively. How the slanted magnetic bearing works can be seen by a small experiment: A magnet attracts iron. One pointed magnet connected to a turning shaft in radial direction and turning inside an iron ring tents to stay axially on the stationary iron ring. (The rotor of an ordinary electrical motor is pulled in the middle besides turned. This effect will be utilized.)

If this ring is slanted to the axis of rotation a reciprocating movement is added to the rotation. The same thing happens in reverse, if the moveable part (reciprocating rotor) has slanted iron rings and every ring communicates with one stationary pointed magnet (permanent or electrical) on a certain spot on the circumference. Since the magnets are now stationer strong adjustable electrical magnets can be used. This device works like a slanted magnetic bearing. It gets the electrical energy from the generator adjacent to it. An ordinary linear generator is changed in a “rotary linear generator” with a common rotating generator.

The magnetic bearing could be used also in other fields, like vibrators, electrical hammer-drills etc.

To avoid excessive wear on pistons and cylinders the sliding speed is always made as low as possible, but generating a strong electrical current needs high speed, but running a piston engine with high speed like a racing engine generates too much wear. For the electrical part is the low speed destructive, because the law of induction demands high speed of two magnetic fields against each other. The higher the speed the higher is the induced current in a conducting medium. Rotating generators deliver enough speed between stator and rotor—ergo between two magnetic fields. Such generators are already widely used and don't need heavy permanent magnets. By adding a rotation to a linear generator conventional generators may be used. Only the stator must be a stroke length elongated. (Since the rotor of such generator gets pulled in the middle this effect can also be utilised.) The electrical part is computerised. An array of sensors delivers always data for location and speed of the moveable part, also data from the engine like pressure in the work chamber etc. The higher the pressure the higher the axial force and the higher must be the electrical current in the slanted magnetic bearing, but only for a short time every revolution, because the pressure in the engine falls fast after ignition.

Using a DC-current only would also be possible for the magnetic bearing, but there would be more thermal loss.

The computer can also handle some ignition failures of the engine by modulating the electrical current in the magnetic bearing.

The electrical parts are basically multifunctional; an electrical generator is simultaneously an electrical motor. This is right for both motions, linear and rotational. They may be used as stand-alone units or be integrated in each other. The ultimate integration would be generator, electrical motor and magnetic bearing in one unit.

### BRIEF DESCRIPTION OF THE DRAWINGS

FIG. 1 shows a longitudinal partial cross section of this rotary linear generator with a rotating generator, a slanted magnetic bearing and two two-stroke engines. The inner electrical part of the movable part is shown in a side view.

FIG. 2 shows a longitudinal partial cross section of the rotary linear generator from FIG. 1 and added a slanted mechanical bearing.

FIG. 3 shows a longitudinal partial cross section of the rotary linear generator from FIG. 2 with the magnetic bearing removed.

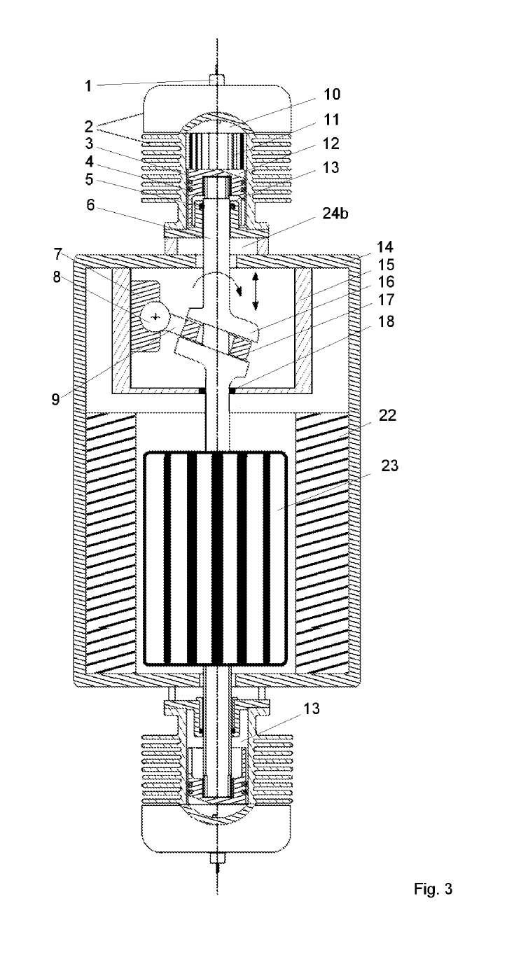

FIG. 4 shows a longitudinal partial cross section of the rotary linear generator from FIG. 1 with the electrical part of a conventional linear generator and added a conventional electrical motor.

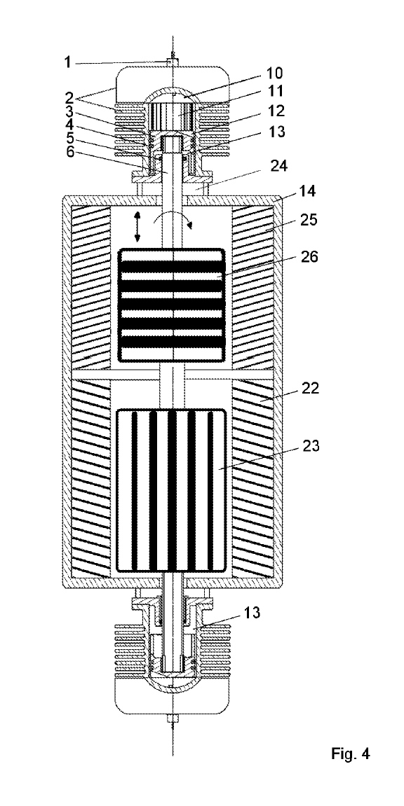

### DETAILED DESCRIPTION OF THE PREFERRED EMBODIMENTS

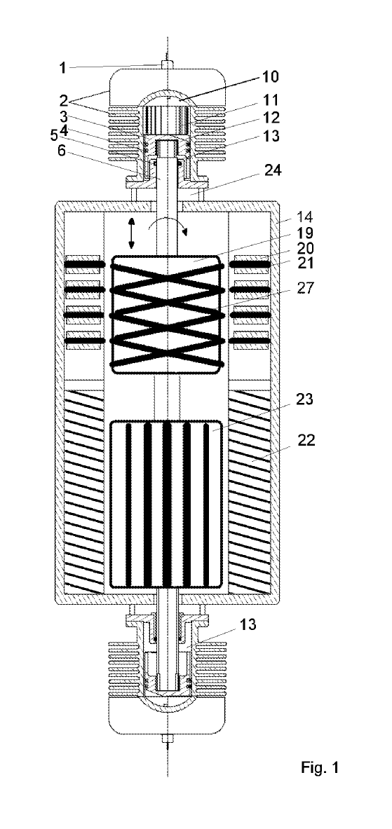

In FIG. 1 is shown a longitudinal partial cross section of this rotary linear generator with a conventional rotating generator comprised of a stator 22 and a rotor 23, a slanted magnetic bearing comprised of a stroke-rotor 19 and stationary parts 20, 21 and two pistons 3 in cylinders 11 from authors two-stroke engine (U.S. application Ser. No. 13/012,973 filed 25 Jan. 2011). There is only one big rigid moveable part (stroke-rotor) with one long shaft 6 connecting the pistons 3 with the inner parts in the housing 14. This moveable part is making both: a stroke motion and a synchronised rotating motion. There is one stroke motion every revolution.

(The inner electrical parts of the movable part are shown in a side view, what explains the function best.)

The two-stroke engine above could drive a normal rotating generator having several moveable parts, specially a slanted bearing. This mechanical bearing is now replaced by a slanted magnetic bearing without any wear parts. Viewing any outside point of the stroke-rotor 19 a slanted, slightly elliptical path is recognised visualized by the slanted iron rings 27 imbedded in the stroke-rotor 19. Every iron ring communicates with only one stationary strong electrical magnet with a cylindrical coil 20 and an iron core 21. (To allow greater coils the magnets may practically shifted along the circumference. In this drawing they are shown in one row for better understanding.) The iron core 21 is cylindrical and pointed on the inner end to generate a constant high density magnetic field and subsequently high forces to the iron rings 27 to accommodate the high piston forces and guide the moving iron rings 27 in a way a rotation is added to the stroke motion of the pistons.

Useable is the axial component of the magnetic force only, because the piston forces are axial directed. The radial component is compensated by placing the same magnet with its communicating ring shifted 180°. The stroke length is the same as the one the pistons make in the cylinders. The load capacity of such a magnetic bearing is limited, therefore are several units in use integrated in one big magnetic bearing strong enough to accommodate the piston forces. Though the coils runs basically a direct-current, but it is controlled by a computerized power unit getting signals from an array of sensors for location and speed of the stroke-rotor and for the pressure in the work chambers 10 of the engines. In this way the coils 20 get the same peak of the electrical current as the pressure peak in the chambers 10 after ignition. In this way the computer handles also ignition failures etc. Even in the extreme case the magnetic bearing loses the grip and the stroke motion get lost it catches the stroke-rotor again. This slanted magnetic bearing replaces a slanted mechanical bearing, but without friction and wear.

Besides the advantage by using environmental two stroke engines a conventional rotating generator can be used, whereby only the stator 22 is a stroke length longer than the rotor 23. The circumference of this rotor is about 6 times longer than the stroke length if the radius is the stroke length, gaining a second advantage of higher speeds between the interacting magnetic fields. The average linear speed of the pistons is always lower, because the pistons stop twice every revolution.

All electrical parts in the housing 14 are thermal separated from the hot engine by a gap 24. There is as less metallic connection as possible, mainly only screws and guiding pins. (Screws are never shown in this simplified drawing.) The engines have cooling fins 2, spark plugs 1, cylinders 11 and pistons 12. The pistons have two compression rings 4. The oil-ring 5 is placed around the shaft 6. The gas is pumped in the combustion chamber by the chamber 13 under the pistons. Rotating control edges 12 and cut-outs (not seen) allow a gas-control like a four stroke engine. There is also no oil in the gasoline.

Friction is low for this design. Even the weight of the big moveable part can be magnetically compensated that mainly only the friction of the piston rings remains. The generator may run with less oil or even total oil-free.

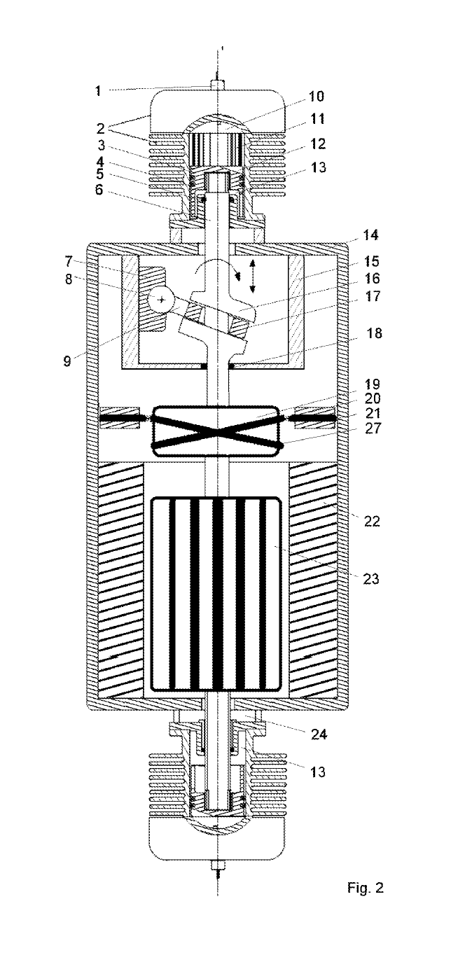

FIG. 2 shows the same rotary linear generator from FIG. 1, but now with a mechanical slanted bearing 16 supporting the slanted magnetic bearing in case the magnetic bearing is not accurate enough.

On the shaft 6 is a slanted bearing 16 accommodating a non-rotating ring 17 connected via a strong pin 9 to a ball 8 in a stationary embedment 7. The ball is able to rotate around its center only. This device adds a stroke motion to a rotation of the shaft or reverse. It assures that the openings and control edges 12 in the pistons 3 run exactly along a predetermined path.

If the magnetic bearing is strong enough this mechanical bearing is a backup only in case the electrical part fails or in case the electrical part is not yet accurate enough. The burden and wear on the mechanical bearing is low.

I claim:

1. A linear generator with a rotating stroke motion, comprising:
an elongated housing with two cylinders and pistons with a rotary stroke motion attached on both ends,
an elongated shaft in the center integrating all moveable parts to one rigid movable part, several electrical parts within the housing thermal separated from the hot engine parts.

2. A rotary linear generator according to claim 1, comprising:
a slanted magnetic bearing accommodating the piston forces with pointed stationary magnets attracting slanted rotating iron rings,
a conventional rotating generator with a stator a stroke length longer than the rotor.

3. A rotary linear generator according to claim 1, comprising:
a slanted magnetic bearing accommodating the piston forces with pointed rotating magnets attracting slanted stationary iron rings,
a conventional rotating generator with a stator a stroke length longer than the rotor.

4. A rotary linear generator according to claims 1 and 2, comprising:
a mechanical slanted bearing consisting of a non-rotating slanted ring around the shaft sliding in a rotating slanted groove and connected via a strong pin to the ball of a stationary swivel bearing,
a conventional rotating generator with a stator a stroke length longer than the rotor.

5. A rotary linear generator according to claims 1, 2 and 4, comprising:
a slanted magnetic bearing accommodating the piston forces with pointed stationary magnets attracting slanted rotating iron rings,
a slanted mechanical bearing consisting of a non-rotating slanted ring around the shaft sliding in a rotating slanted groove and connected via a strong pin to the ball of a stationary swivel bearing,
a conventional rotating generator with a stator a stroke length longer than the rotor.

6. A rotary linear generator according to claim 1, comprising:
an electrical part of a conventional linear generator,
a conventional rotating electrical motor site by site on the same shaft.
